(19) United States
(12) Patent Application Publication
(10) Pub. No.: US 2010/0224034 A1
(43) Pub. Date: Sep. 9, 2010

(54) Compression Nut Removal Device

(76) Inventor: Brian Joseph Fitzpatrick, (US)

Correspondence Address: Brian Joseph Fitzpatrick, 5705 Southview Dr, Yorba Linda, CA, 92887, US

(21) Appl. No.: 12/713,486

(22) Filed: Feb. 26, 2010

Related U.S. Application Data
(60) Provisional application No. 61/158,076, filed on Mar. 6, 2009.

(51) Int. Cl. B25B 21/00

(52) U.S. Cl. 81/57.42

(57) ABSTRACT

The present invention is an embodiment of a machine-enabled compression nut and ferrule removal device. The compression nut puller of the present invention features a shaft attachment for insertion into a mechanized hand drill to enable swift and easy removal of heavily torqued compression nuts. The invention also includes a base support plate with the enhanced compression removal assistance of a metal support housing for the shaft, and a pipe attachment sleeve. This allows for powered rotation of the axle of the shaft while the supports remain stationary, which enables the quick removal of a tightly compressed nut and ferrule, whether it is deformed, corroded, or otherwise damaged.

This application claims priority of provisional patent application. Application number 61/158,076 filing date Mar. 6, 2009

### BRIEF DESCRIPTION OF THE DRAWINGS

FIG. 1 is a lateral view of the device of the invention placed on a pipe to remove a nut.

FIG. 2 shows a common plumbing fixture with a compression nut fitting.

FIG. 3 shows the device of the invention.

FIG. 4 shows the device in place to remove a nut with a power drill attached to the axle of the device. The hand drill is shown in dotted lines, and is not part of the current invention.

Wherein

10 is the structural support housing of the device

20 is the shaft of the device

30 is the locking collar on the device

40 is the turning axle of the device

45 is the pipe attachment sleeve

50 is the upper support plate of the device

60 is the pipe bearing the compression nut be to removed

62 is the ferrule

64 is the compression nut

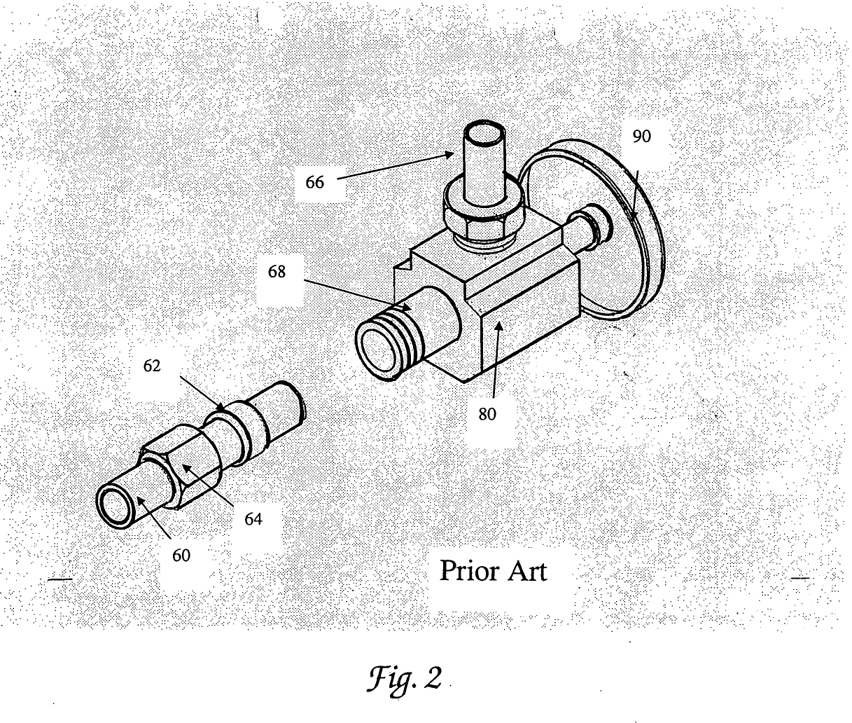

66 is the supply pipe to the plumbing fixture of FIG. 2

68 is a connector pipe having a male threaded end

70 is the base support plate of the device

80 is a valve body within a stop valve plumbing fixture,

90 is the knob on the stop valve

### FIELD OF THE INVENTION

The present invention relates to the field of plumbing tools, and more specifically to the field of machine-powered plumbing tools used for the removal of heavily torqued compression ferrule and nuts.

### BACKGROUND OF THE INVENTION

Prior art has seen developed various devices used for the removal of compression nuts and ferrule once they have been attached to the end of a water pipe and screwed down to their given torque specifications. A standard stop valve utilizes the rear threads to apply pressure, which seals the compression gasket securely to the nut, while the outside diameter grips the pipe to keep it from rotating and thereby loosening itself off of the stop valve.

Although this provides the most secure bonding for the present application, it presents the formidable task of removing the nut once it has become corroded and/or deformed due to the extended time of pressure. Another problem presented by this application is the difficulty of nut removal without scarring or deforming the pipe in some way, making the insertion and sealing of a new washer impossible. On many occasions, plumbers are left with no other option than to saw off the rear end of a compression washer. Unfortunately, this method for circumventing the problem can only be utilized a limited number of times, and is destructive of otherwise perfectly functional water lines. There has been a need for the ease provided by machine assistance, as prior art has not developed a drill-assisted compression nut puller.

### BRIEF SUMMARY OF THE INVENTION

The present invention has been developed to provide machine-enhanced removal of compression nuts. It is equipped with a shaft or axle for the attachment of a machine-powered hand drill at one end, which will propel the turning axle of the open cylindrical housing that houses the pipe attachment sleeve.

The shaft projects from within the housing, and ends in a reinforced block, which is itself attached to the shaft attachment arm. When a hand drill is connected to the shaft attachment arm, the added strength of machine-powered assistance is enabled.

### DETAILED DESCRIPTION OF THE INVENTION

The present invention provides a machine-enabled compression ferrule and nut removal device. The compression nut puller of the present invention features a shaft attachment for the insertion of a mechanized hand drill to enable swift and easy removal of heavily torqued compression nuts.

One embodiment of the present invention comprises a base support housing with the enhanced compression removal assistance of the reinforced housing and a pipe attachment sleeve. Power assistance quickly rotates the axle of the shaft while the housing remains stationary, which enables the quick removal of a tightly compressed ferrule and nut, whether it is deformed, corroded or otherwise damaged. The design is sufficiently robust to withstand the torque generated by a hand-held power drill.

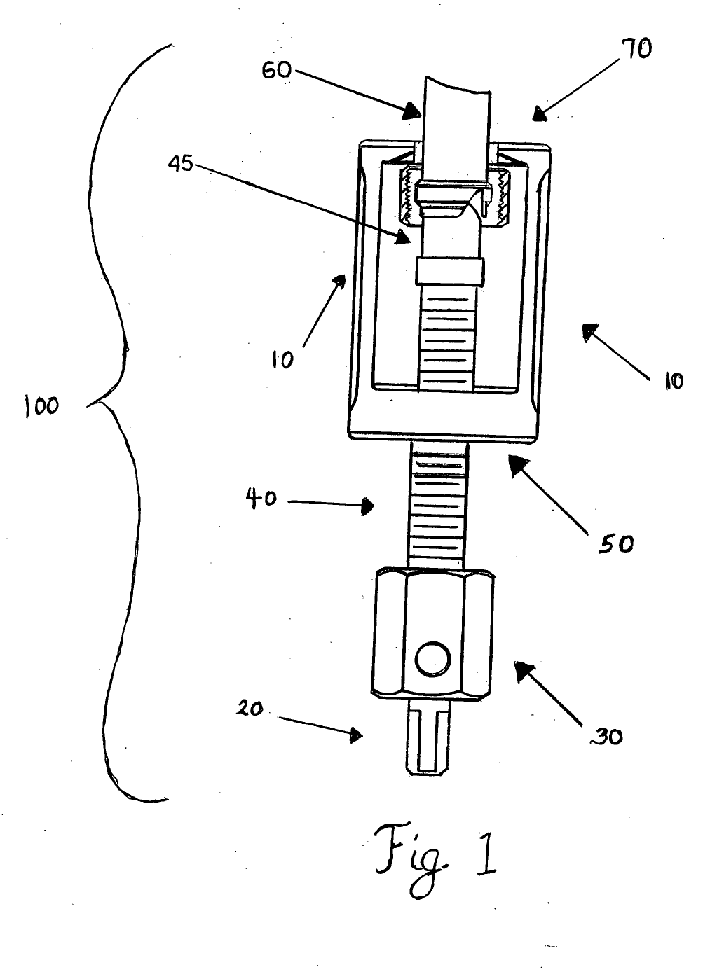

The device and its operation are best understood by reference to the FIGS. 1-4. The situation addressed by the invention can be understood by reference to FIG. 2, a drawing of a common plumbing stop valve comprising a compression nut. This particular drawing portrays a stop valve water supply fixture, as is commonly found underneath sinks in the kitchen and bathroom. The water from the wall pipes exits pipe 60 which is connected to pipe 68 by means of a threaded connection, the male thread on the end of connector pipe 68, and the female thread inside compression nut 64. There is further a compression ferrule 62 on pipe 60 to help prevent leaks. The water in pipe 68 is delivered to valve body 80. A knob 90 controls the valve (not shown) inside body 80. When the knob 90 is placed in the closed position, no water flows beyond the supply valve. When the knob 90 is turned to an open position, water moves further into tube 66, which delivers water to the faucet. Faucet controls (not shown) then deliver water for use in the sink. The problem that the present invention is designed to solve is illustrated by this FIG. 2. Compression nut 64 is designed to compress down upon ferrule 62 when being threaded upon the thread on pipe 68. This creates a tight seal, which is designed to prevent water leaking out of the junction of pipe 60 and pipe 68. However, the compression nut 64 and 62 ferrule can perform their appointed task too well. After many years of use, in a continuously wet environment (remember that water stops at the valve in 80, well beyond the compression fitting), compression nut 64 can become fixed in place, and virtually impossible to loosen, or indeed turn at all.

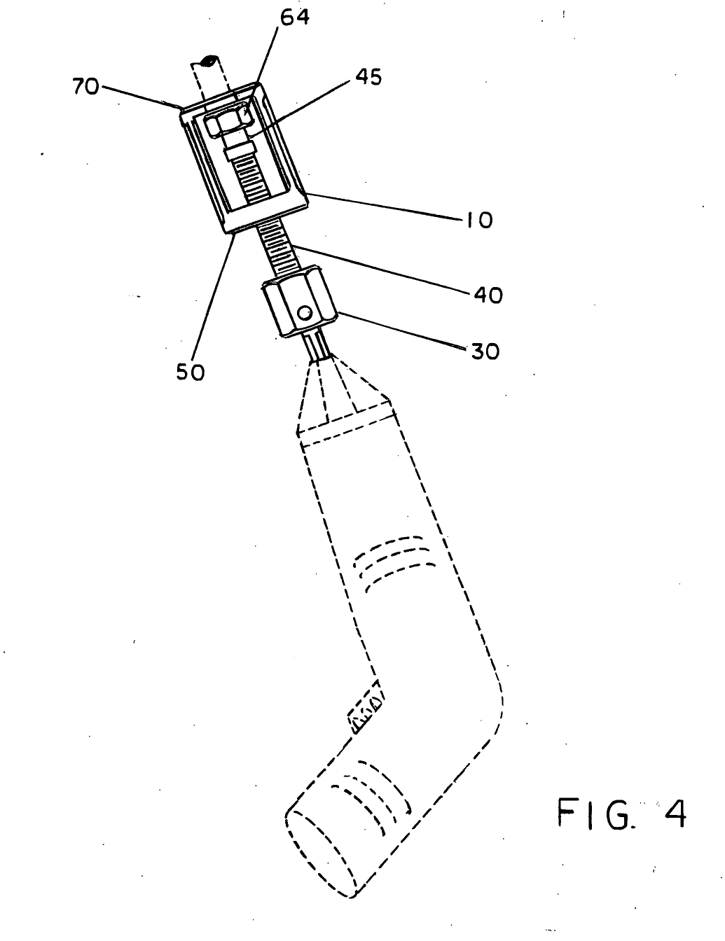

FIG. 1 shows a side view of the present embodiment without a drill present 100. This embodiment utilizes motorized assistance by way of an ordinary hand drill (not shown in this figure) connecting to the shaft 20, by insertion into the chuck of the drill, in the same manner as a drill bit is inserted therein. The locking collar 30 aids in securing the invention to the drill. When the drill is operated, it turns the shaft 20, which turns the turning axle 40 to loosen the compression nut. This design utilizes both upper support plate 50 and base support plate 70 in addition to structural support housing 10 to create an extra rigid and solid platform to loosen even the most stubborn compression nuts. The pipe attachment sleeve 45 is placed upon the threaded pipe with the stubborn nut with ample pressure. The base support plate 70 is positioned on the opposing side of the stubborn nut 64 (seen in FIG. 2) with ample pressure. This process, with the aid of a hand drill (seen in FIG. 4) and structural support housing 10, exerts enough pressure and support to safely remove most stubborn or corroded nuts.

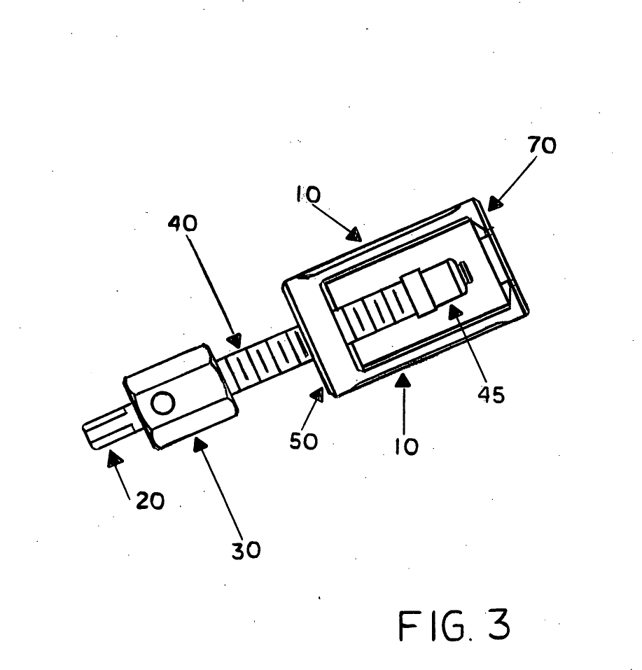

FIG. 3 shows a perspective view of the device of the present invention, without attachments, such as a hand drill. The hand drill or other power source, or even a hand-turned handle, is attached at shaft end 20. Locking collar 30 is present to ensure the shaft end 20 is firmly attached to axle 40. At the other end of axle 40 is pipe attachment sleeve 45. This sleeve also is firmly attached to axle 40. The sleeve can engage a water supply pipe upon being inserted therein. At the same time, the lower plate 70 is placed such that the cutout area in the plate will engage a nut on said water pipe. When the shaft 20 is turned, thus turning axle 40 and pipe attachment sleeve 45, force is applied to the nut to force it to turn, and thus release its grip on the pipe. Structural support housing 10 is shown in skeletal view only in this figure, in order to highlight other elements of the current invention.

Note that the sleeve 45 can be replaced by another sleeve of different diameter, in order to accommodate a pipe of unusual diameter. In the same manner, lower base plate 70 can be exchanged for a similar plate with a different size of cutaway area, in order to engage nuts of differing sizes. FIG. 4 shows an angled view of the present embodiment which utilizes motorized assistance by way of an ordinary hand drill connecting to the shaft 10 which turns the turning axle 40 to loosen the compression nut 64. This design utilizes both upper support plate 50 and base support plate 70 in addition to structural support housing 10 to create an extra rigid and solid platform to loosen even the most stubborn compression nuts. The pipe attachment sleeve 45 is placed upon the threaded pipe with the stubborn nut with ample pressure. The base support plate 70 is positioned on the opposing side of the stubborn nut 64 with ample pressure. This process, with the aid of the action of a standard hand drill and structural support housing 10, exerts enough pressure and support to safely remove most stubborn or corroded nuts.

Note that the invention will loosen virtually any type of nut that surrounds a pipe or tubing. Thus, it is not limited to compression nuts, to water supply lines, or the like. However, it is designed for service with compression nuts on water supply lines, for experience teaches that this is a very common problem area encountered by plumbers, both professional and amateur.

The present invention provides several advantages over the prior art. One advantage of the present invention is that it facilitates the removal of stuck or frozen nuts, primarily because it exerts more force than common hand wrenches used traditionally to unstuck frozen nuts or screw heads.

Yet another advantage of the current invention is that it helps to prevent skinned or injured fingers and hands, as commonly occurs in stuck plumbing fixture situations of the type described herein.

Still another advantage of the current invention is that it is easily fitted with different power sources, to facilitate job with different torque requirements.

Yet another advantage of the current invention is to allow adaptability to accommodate various sizes of pipes and of compression nuts.

Further objects and advantages will become apparent from a consideration of the ensuing description and drawings. Note that not all embodiments of the current invention may accomplish all of the above objectives in a single embodiment. Taken as a whole, the objectives are met through different embodiments of the invention.

Detailed descriptions of the preferred embodiment are provided herein. It is to be understood, however that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

While the above description contains much specificity, these should not be construed as limitations on the scope of the invention, but rather as exemplifications of one preferred embodiment thereof. Therefore, although the invention has been described in connection with a preferred embodiment or set of embodiments, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for removing a compression nut and ferrule from a pipe comprising a central axle extending through an upper base plate of a housing and toward a lower base plate, said lower plate adapted to engage the compression nut; the axle having a sleeve adapted to engage said pipe at the end of said axle that approaches the lower base plate and an adapter to engage a powering device at the opposite end; whereby when the nut is engaged by the base plate and the axle sleeve, and power is applied to turn the axle, the engaged nut is turned and removed.
